(19) United States
(12) Patent Application Publication
(10) Pub. No.: US 2013/0019762 A1
(43) Pub. Date: Jan. 24, 2013

(54) CONDENSATE GUIDING SYSTEM AND STEAM COOKER INCLUDING THE SAME

(71) Applicants: Jeongkil KIM, Changwon-si (KR); Youngil Shin, Changwon-si (KR); Sejin Park, Changwon-si (KR); Keunjae Hwang, Changwon-si (KR); Jeongik Heo, Changwon-si (KR)

(72) Inventors: Jeongkil KIM, Changwon-si (KR); Youngil Shin, Changwon-si (KR); Sejin Park, Changwon-si (KR); Keunjae Hwang, Changwon-si (KR); Jeongik Heo, Changwon-si (KR)

(21) Appl. No.: 13/553,908

(22) Filed: Jul. 20, 2012

(30) Foreign Application Priority Data
Jul. 21, 2011 (KR) 10-2011-0072667

(51) Int. Cl. A47J 27/04

(52) U.S. Cl. 99/403; 137/312

(57) ABSTRACT

Provided are a condensate guiding system and a steam cooker including such a condensate guiding system. The condensate guiding system may include a condensate collector and a condensate guide. The condensate collector may collect condensate formed from steam included in air discharged from the cooking chamber. Condensate that flows along an inner surface of the steam cooker, and that is discharged out of the steam cooker, may be guided to the condensate collector by the condensate guide.

### CROSS-REFERENCE TO RELATED APPLICATION

This application claims priority under 35 U.S.C. §119 to Korean Application No. 10-2011-0072667 filed in Korea on Jul. 21, 2011, whose entire disclosure is hereby incorporated by reference.

### BACKGROUND

1. Field

This relates to a steam cooker.

2. Background

Cookers may cook food using heat generated from electricity or gas. Cookers may supply steam to food to compensate for moisture loss due to evaporation during cooking. Such a steam cooker may supply steam into a cooking chamber for cooking food. This steam may carry foreign substances, such as oil or moisture, from the cooking chamber to the outside of the cooker, causing the exterior of the cooker and the room in which it is installed to be contaminated.

### BRIEF DESCRIPTION OF THE DRAWINGS

The embodiments will be described in detail with reference to the following drawings in which like reference numerals refer to like elements wherein:

FIG. 1 is a perspective view of a cooker according to an embodiment as broadly described herein.

FIG. 2 is an exploded perspective view of the cooker shown in FIG. 1.

FIG. 3 is a perspective view of a condensate collector of the cooker shown in FIG. 1.

FIG. 4 is a perspective view of a condensate guide of the cooker shown in FIG. 1.

FIG. 5 is a vertical cross-sectional view of an edge portion of the cooker shown in FIG. 1.

### DETAILED DESCRIPTION

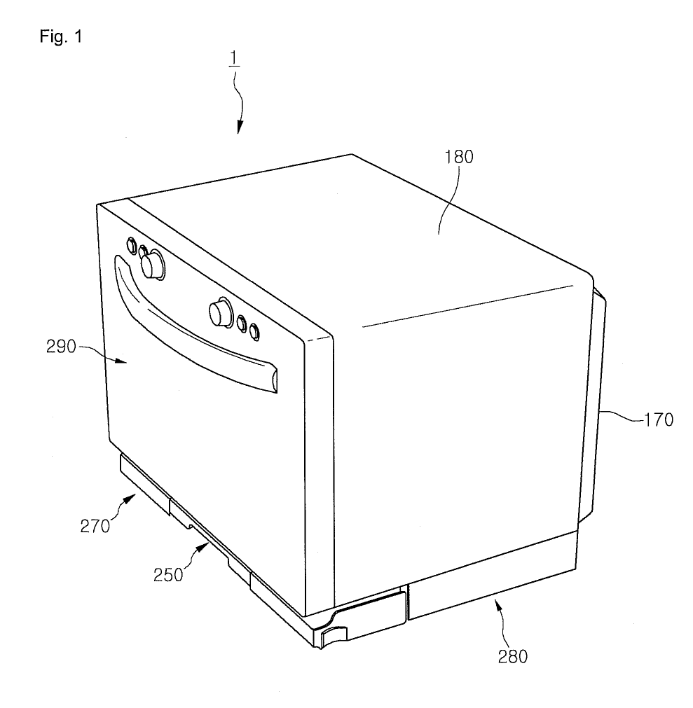

Referring to FIGS. 1 to 5, a steam cooker 1 as embodied and broadly described herein may include a cavity 100 in which a cooking chamber 101 is provided for cooking food therein. The cavity 100 may include a top plate 110, a bottom plate 120, a rear plate 130, and two side plates 140. The top and bottom plates 110 and 120 may respectively define top and bottom surfaces of the cavity 100, the rear plate 130 may define a rear surface of the cavity 100, and the side plates 140 may define two opposite side surfaces of the cavity 100. Accordingly, the cavity 100 may have a substantially polyhedral shape with an open front face. The top and bottom plates 110 and 120 may substantially define the top and bottom surfaces of the cooking chamber 101, respectively, and the rear plate 130 and the side plates 140 may define the rear and side surfaces of the cooking chamber 101, respectively.

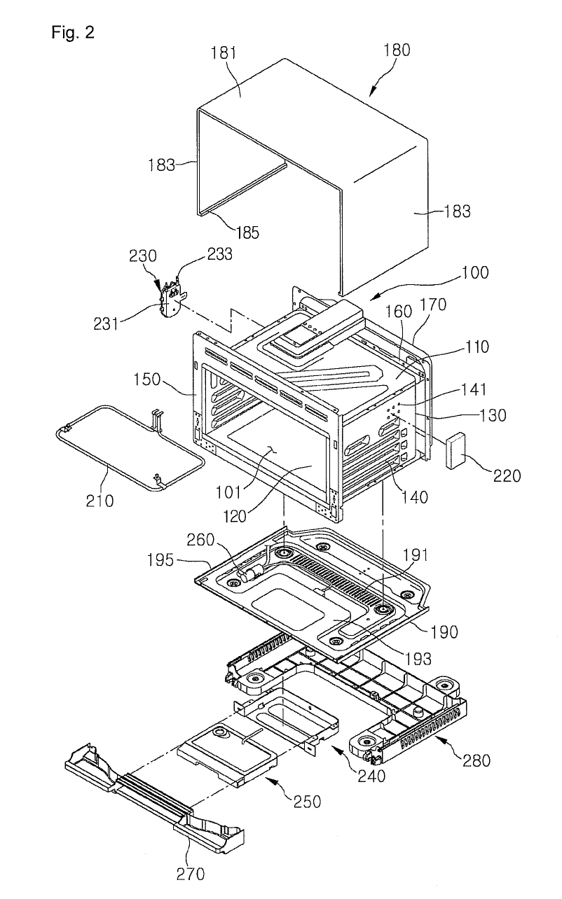

One of the side plates 140, for example, the right side plate 140 shown in FIG. 2, may include exhaust holes 141. Air, introduced together with microwaves into the cooking chamber 101 through an irradiation opening, may be discharged out of the cooking chamber 101 through the exhaust holes 141. One of the side plates 140, for example, the left side plate 140 shown in FIG. 2, may include a steam injection hole through which steam generated by a steam generator 230 may be introduced into the cooking chamber 101.

A front plate 150 and a back plate 160 may be respectively positioned at the front end and the rear surface of the cavity 100, with the inner surface of the front plate 150 fixed to the front ends of the top plate 110, the bottom plate 120, and the side plates 140. A portion of the front surface of the back plate 160 may be fixed to a portion of the rear surface of the rear plate 130. The front plate 150 and the back plate 160 may horizontally and vertically extend to the outside of the cavity 100.

A back cover 170 may cover the back plate 160. An electric component chamber may be provided, for example, between the back plate 160 and the back cover 170 to accommodate various electric components such as, for example, a magnetron and a fan for cooling the electric components. A portion of air moved by the cooling fan may be transferred to the cooking chamber 101, and may convey foreign substances and steam from the cooking chamber 101 to the outside thereof through the exhaust holes 141.

An outer case 180 may cover the top plate 110 and the side plates 140 so that the back cover 170 and the outer case 180 essentially define the rear, top, and side appearances of the steam cooker 1. The outer case 180 may include a top panel 181 and two side panels 183. The top panel 181 may form the top external appearance of the steam cooker 1, and the side panels 183 may form the side external appearances of the steam cooker 1. The side panels 183, extending downward from the two opposite ends of the top panel 181, may be integrally formed with the top panel 181.

Guide flanges 185 may be formed at lower ends of the side panels 183, for example, by bending a portion of the lower ends of the side panels 183 to form a certain angle, for example, 90 degrees with respect to the side panels 183. The guide flanges 185 may be spaced a preset distance from a bottom surface of a base plate 190 on which the cavity 100 is positioned. The guide flanges 185 may guide condensate, formed from steam contacting the inner surface of the side panels 183, to guide channels 284 to be described later.

The base plate 190 may be fixed to the lower portion of the cavity 100 and have a plate shape with a certain area. The top edge of the base plate 190 may be fixed to the lower ends of the front plate 150, the back cover 170, and the outer case 180. An exhaust port 191 may be provided in the base plate 190, spaced forward from the lower end of the back plate 160, to guide air, discharged through the exhaust holes 141, to the outside. The exhaust port 191 may also guide condensate, formed from steam included in the air discharged through the exhaust holes 141, to a condensate guide 280 having the guide channel 284 formed therein. Legs may be provided at the bottom corners of the base plate 190.

The base plate 190 may include a housing installation part 193 formed by, for example, an upwardly protruding portion of the base plate 190 in front of the exhaust port 191. A tank housing 240 may be installed on the housing installation part 193. A through hole may be formed at the rear end of the housing installation part 193.

A fixing flange 195 may be formed along the edge of the base plate 190. The fixing flange 195 may be formed by an upwardly bent portion of the edge of the base plate 190 such that the fixing flange 195 may contact corresponding inner portions of the front plate 150, the back cover 170, and the outer case 180. Particularly, the fixing flange 195 may contact the outer case 180 at, for example, the inner lower ends of the side panels 183. Coupling members (not shown), sequentially passing through the side panels 183 and the fixing flange 195, may fix the outer case 180 and the base plate 190.

An upper heater 210 may be provided in an upper portion of the cooking chamber 101. The upper heater 210 may radiantly heat food in the cooking chamber 101. The upper heater 210 may be, for example, a sheath heater.

In certain embodiments, an additional heating source for cooking food in the cooking chamber 101 may be disposed in the cavity 100. For example, a carbon heater may be provided in the upper portion of the chamber 101 as an additional irradiation heating source. Alternatively, or additionally, convection system may be disposed between the rear plate 130 and the back plate 160 to circulate high temperature air within the cooking chamber 101. A lower heater may be provided in the lower portion of the cooking chamber 101.

The side plate 140 in which the exhaust holes 141 are formed, for example, the right side plate 140 shown in FIG. 1, may be provided with an exhaust duct 220 to guide air discharged through the exhaust holes 141, that is, air discharged from the cooking chamber 101 after circulating within the cooking chamber 101, to the exhaust port 191. To this end, the exhaust duct 220 may have a polyhedral shape with an open side portion and an open bottom, and may be provided on the side plate 140 to cover the exhaust holes 141. Air discharged through the exhaust holes 141 may flow between the side plate 140 and the exhaust duct 220, and then, may be discharged through the open bottom of the exhaust duct 220.

The side plate 140 opposite the side at which the exhaust duct 220 is provided, for example the left side plate 140 shown in FIG. 2, may have the steam generator 230 attached thereto. The steam generator 230 may generate steam to be supplied to the cooking chamber 101. The steam generator 230 may include, for example, a steam chamber 231 receiving water and a steam heater 231 for heating the water received in the steam chamber 231 to generate steam.

The tank housing 240 may be disposed under the bottom central portion of the base plate 190, that is, under the housing installation part 193. The tank housing 240 may have a polyhedron shape with at least an open front. For example, the tank housing 240 may have a hexahedron shape with an open front and an open top such that the base plate 190 and the tank housing 240 define a certain space. A water supply tank 250 may be removably inserted in the tank housing 240, substantially, in the space defined by the base plate 190 and the tank housing 240. The water to be supplied to the steam generator 230 may be stored in the water supply tank 250. A water supply pump 260 may be provided between the bottom plate 120 and the base plate 190 to pump the water from the water supply tank 250 to the steam generator 230.

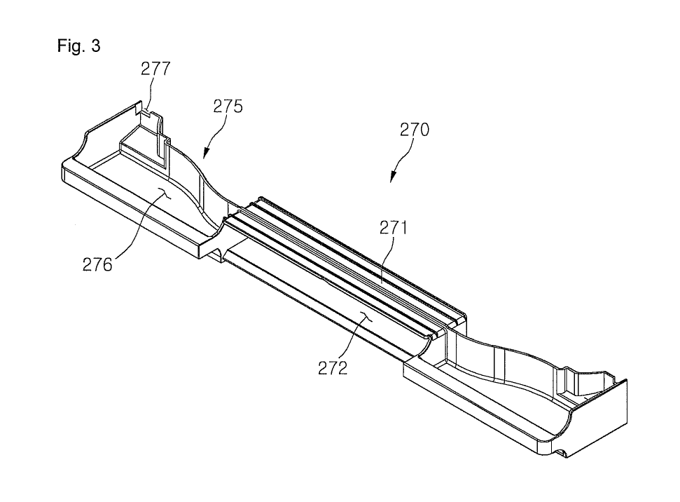

A condensate collector 270 may be positioned under the front bottom surface of the base plate 190 to collect condensate discharged along the front surface of the cavity 100, that is, the front surface of the front plate 150, or the inner surface of a door 290 that extends across the open front face of the chamber 101. Referring to FIG. 3, the condensate collector 270 may include a gate 271 and two collector parts 275. The gate 271 may be disposed at a central portion of the condensate collector 270, and the collector parts 275 may be disposed at the two ends of the condensate collector 270 on opposite sides of the gate 271.

The gate 271 may include a gate opening 272 through which the water supply tank 250 may be removably inserted in the tank housing 240. The collector parts 275 may include collecting spaces 276 for collecting condensate. Channel installation openings 277 may be formed in the rear surfaces of the collector parts 275. The channel installation openings 277 may be formed by, for example, cutting a portion of the rear surfaces of the collector parts 275. A portion of the fronts of the guide channels 284 may be received in the channel installation openings 277.

The condensate collector 270 may include coupling protrusions that extend rearward from the rear surface of the condensate collector 270, for example, from the rear surfaces of the collector parts 275.

The condensate guide 280 may be positioned under the bottom side ends and rear end of the base plate 190 out of the tank housing 240 and the condensate collector 270. The condensate guide 280 may guide condensate formed from steam included in air discharged through the exhaust holes 141 to the outside of the cooking chamber 101. The condensate guide 280 supports a portion of the base plate 190. Thus, the condensate guide 280 may be referred to as a base supporter.

The condensate guide 280 may have an approximately polyhedron shape with an open top and an open front such that a horizontal cross-section has an angled U shape to facilitate the installation of the tank housing 240 and the water supply tank 250. Thus, the shape of the condensate guide 280 may be varied with the shape and arrangement of the tank housing 240 and the water supply tank 250. The condensate guide 280 may support the side ends and rear end of the base plate 190. The front surface of the condensate guide 280 may contact the rear surface of the condensate collector 270, or be spaced a certain distance therefrom.

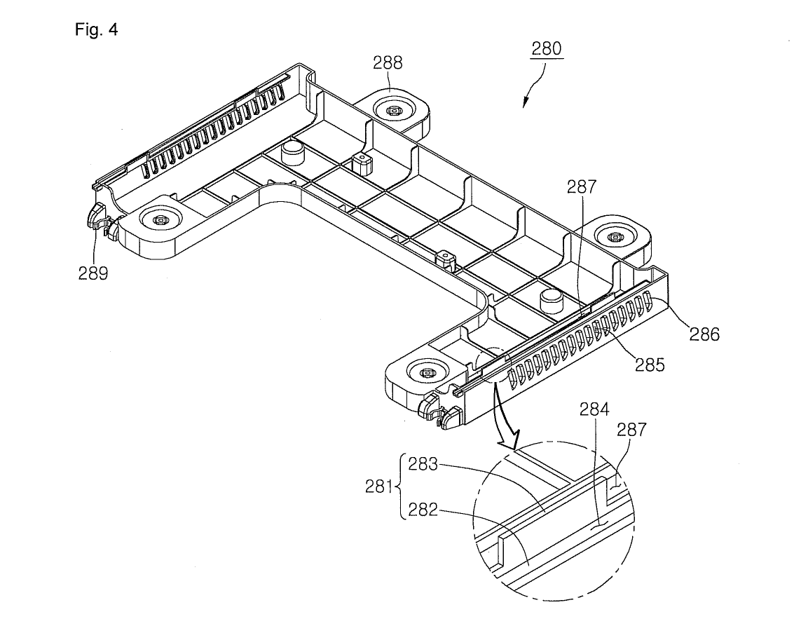

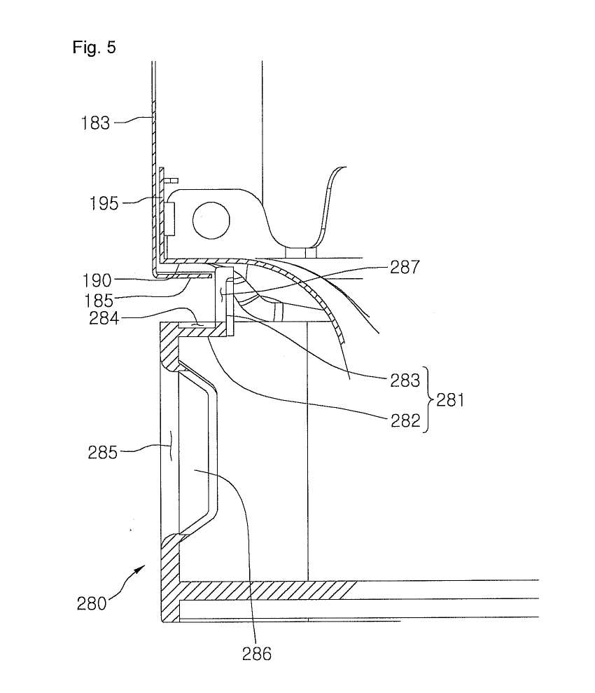

Referring to FIGS. 4 and 5, support ribs 281 may be provided on the inner top side of the condensate guide 280 to support the bottom surface of the base plate 190. Each support rib 281 may include an extension 282 and a support 283. The extensions 282 may extend horizontally along the inner side surfaces of the condensate guider 280 and may be spaced downward from the upper side ends of the condensate guide 280 by a certain distance. The supports 283 may extend upward from ends of the extensions 282 so that the upper ends of the supports 283 support the bottom surface of the base plate 190. The support ribs 281 may extend along the longitudinal direction of the condensate guide 280 on both upper inner side surfaces of the condensate guide 280. The supports 283 may be inclined in a front lower direction thereof, overall, such that the front ends of the supports 283 are lower than the rear ends thereof. A portion of the front ends of the support ribs 281 may further extend to the front side of the condensate guide 280.

The guide channels 284 may be formed in both top sides of the condensate guide 280. Condensate flowing along the outer case 180, substantially, along the inner surfaces of the side panels 183, may be guided to the condensate collector 270 by the guide channels 284. In more detail, a portion of steam included in air discharged through the exhaust holes 141 to the outside of the cooking chamber 101 may be condensed on the inner surface of the outer case 180, substantially, on the inner surfaces of the side panels 183. Then, the condensed steam, that is, condensate, may flow down to the guide channels 284 and be guided to the condensate collector 270 by the guide channels 284.

The guide channels 284 extend along the longitudinal direction of the condensate guide 280 in both side ends of the condensate guide 280. In certain embodiments, the guide channels 284 may be defined by both the side portions of the condensate guide 280 and the support ribs 281. Thus, a vertical cross-section the guide channel 284 may have an angled U shape with an open top. The guide channels 284 may be inclined in a front lower direction corresponding to the shape of the support ribs 281, with the front ends of the guide channels 284 extending into the collector parts 275, that is, into the collecting spaces 276. That is, the front ends of the guide channels 284 may be placed in the channel installation openings 277.

The condensate guide 280 may include air outlets 285 and 287. Air may be discharged between the base plate 190 and the condensate guide 280 through the air outlets 285 and 287. The air outlets 285 and 287 may include a plurality of first air outlets 285 and a plurality of second air outlets 287.

The first air outlets 285 may be formed by partially cutting the side portions of the condensate guide 280. The first air outlets 285 may be vertically elongated and may include louvers 286 such that air discharged through the first air outlets 285 may be guided rearward by the louvers 286. The first air outlets 285 may be inclined with the upper ends thereof being disposed more forward than the lower ends thereof. Thus, air discharged through the first air outlets 285 and guided by the louvers 286 may obliquely flow to the rear upper side of the steam cooker 1.

The second air outlets 287 may be formed by partially cutting the support ribs 281, in particular, the supports 283. The lower ends of the second air outlets 287 may be spaced upward from the extensions 282. Since the second air outlets 287 are formed by partially cutting the support ribs 281, the support ribs 281 and the second air outlets 287 may be alternately disposed along a single plate member.

Base fixing parts 288 may be provided on the condensate guide 280. The base fixing parts 288 may be formed by partially and backwardly protruding the condensate guide 280. The base fixing parts 288 may be fixed to the base plate 190.

Coupling hooks 289 may be provided on the front surface of the condensate guide 280. The coupling protrusions may be coupled to the coupling hooks 289. Accordingly, the condensate collector 270 may be prevented from being accidentally removed from the condensate guide 280. Particularly, when the water supply tank 250 is inserted or removed through the gate opening 272, the condensate collector 270 may be prevented from being accidentally removed from the condensate guide 280.

The cooking chamber 101 may be selectively opened and closed by the door 290. For example, the upper end of the door 290 may rotate about the lower end thereof in a pull-down manner to open and close the cooking chamber 101.

Hereinafter, operation of a steam cooker according to an embodiment will now be described with reference to the accompanying drawings.

First, when the steam cooker 1 is operated to cook food with steam, steam generated by the steam generator 230 is supplied into the cooking chamber 101. At this point, the upper heater 210 and/or the convection system and/or the lower heater may be operated. In addition, the cooling fan may be operated to supply air into the cooking chamber 101. The steam supplied into the cooking chamber 101, and various foreign substances such as moisture and oil discharged from the food cooked within the cooking chamber 101, are carried to the outside of the cooking chamber 101 through the exhaust holes 141 by the air supplied into the cooking chamber 101.

The air discharged to the outside of the cooking chamber 101 is guided downward by the exhaust duct 220, and is discharged to the space defined by the cavity 100, the base plate 190, and the outer case 180. Then, the air discharged to the space defined by the cavity 100, the base plate 190, and the outer case 180 is discharged through the exhaust port 191 to the space between the base plate 190 and the condensate guide 280.

Then, the air discharged to the space between the base plate 190 and the condensate guide 280 is discharged through the first and second air outlets 285 and 287 to the outside of the base plate 190 and the condensate guide 280. At this point, the steam included in the air discharged to the space between the base plate 190 and the condensate guide 280 may be discharged together with the air, or be condensed to remain as condensate in the condensate guide 280. The condensate remaining in the condensate guide 280 may be naturally evaporated by air flowing between the base plate 190 and the condensate guide 280 through the exhaust port 191 and the first and second air outlets 285 and 287.

In more detail, a portion of the steam included in the air discharged through the exhaust holes 141 to the space defined by the cavity 100, the base plate 190, and the outer case 180 may contact the inner surface of the outer case 180, in particular, on the inner surfaces of the side panels 183, and be condensed. The steam condensed on the inner surfaces of the side panels 183, as condensate, flows down along the inner surfaces of the side panels 183 into the guide channels 284. Since the guide channels 284 are inclined in the front lower direction, the condensate in the guide channels 284 flows to the condensate collector 270.

As a result, the condensate formed from the steam contacting the inner surfaces of the side panels 183 is collected in a separate space, that is, in the condensate collector 270, by the condensate guide 280, without being directly discharged to an outside thereof, such as a floor on which the steam cooker 1 is placed. Thus, contamination of a kitchen containing the steam cooker 1 may be minimized.

According to embodiments as broadly described herein, the side portion of a condensate guide, and a support rib supporting a base plate may define a guide channel, and second air outlets may be formed by partially cutting the support rib, which may essentially define a support. However, the guide channel may be defined by the side portion of the condensate guide and a guide rib. In this case, the guide rib may have approximately the same height as that of the side portion of the condensate guide. In addition, the support rib may be taller than the guide rib so as to support the base plate. Alternatively, support ribs may be intermittently arranged on the upper end of the guide rib, and the spaces between the support ribs may function as the second air outlets.

According to embodiments as broadly described herein, condensate to be discharged out of a steam cooker may be collected in a condensate collector, without being directly discharged out of the cooker and onto, for example, a floor surface on which the steam cooker is positioned. Thus, the steam cooker may be used more cleanly.

Embodiments provide a condensate guiding system and a steam cooker including such a condensate guiding system.

In one embodiment, a condensate guiding system for a steam cooker may include a cooking chamber for cooking food, a steam generator generating steam to be supplied into the cooking chamber, a condensate collector collecting condensate formed from steam included in air discharged from the cooking chamber, and a condensate guide provided such that condensate that flows along an inner surface of the steam cooker and is discharged out of the steam cooker is guided to the condensate collector.

In another embodiment, a steam cooker as broadly described herein may include a cavity comprising a cooking chamber, an outer case covering a top and two opposite side portions of the cavity, a steam generator generating steam to be supplied into the cooking chamber, a condensate collector collecting condensate formed from the steam supplied into the cooking chamber, and a condensate guide positioned such that condensate formed from steam contacting an inner surface of the outer case is guided to the condensate collector.

In another embodiment, a steam cooker as broadly described herein may include a cavity comprising a cooking chamber, an outer case covering a top and both side portions of the cavity, a base plate under the cavity, a steam generator generating steam to be supplied into the cooking chamber, a condensate collector comprising a collecting space in which condensate formed from the steam supplied into the cooking chamber is collected, a condensate guide having guide channels formed therein such that condensate formed from steam contacting an inner surface of the outer case is guided to the collecting space, and a door selectively opening and closing the cooking chamber.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A condensate guiding system for a steam cooker, the steam cooker comprising a cooking chamber and a steam generator that supplies steam to the cooking chamber, the condensate guiding system comprising:
a condensate collector positioned proximate a lower end of the cooking chamber so as to collect condensate formed from steam included in air discharged from the cooking chamber; and
a condensate guide that provides for fluid communication between a wall surface of the steam cooker and the condensate collector so as to guide condensate flowing along the wall surface of the steam cooker into the condensate collector.

2. The condensate guiding system of claim 1, wherein the condensate guide comprises at least one guide channel formed therein that guides the condensate to the condensate collector.

3. The condensate guiding system of claim 1, wherein the condensate guide comprises at least one guide channel that is inclined downward toward the condensate collector to guide the condensate to the condensate collector.

4. The condensate guiding system of claim 2, wherein the at least one guide channel comprises at least one first guide channel extending along a first end of the condensate guide and at least one second guide channel extending along a second end of the condensate guide opposite the first end thereof, and wherein the at least one first guide channel and at least one second guide channel guide condensate from respective wall surfaces of the steam cooker into first and second collection spaces formed in the condensate collector, respectively.

5. The condensate guiding system of claim 1, wherein the condensate collector and condensate guide are disposed on a bottom surface of the steam cooker.

6. The condensate guiding system of claim 1, wherein the condensate guide comprises at least one air outlet formed therein, wherein air that has circulated through the steam cooker and then between a bottom surface of the steam cooker and the condensate guide is discharged out of the steam cooker through the at least one air outlet.

7. The condensate guiding system of claim 6, wherein the at least one air outlet comprises:
a first air outlet provided under a corresponding guide channel formed in the condensate guide for guiding the condensate to the condensate collector; and
a second air outlet provided above the corresponding guide channel.

8. A steam cooker, comprising:
a cavity comprising a cooking chamber;
an outer case covering a top and two opposite lateral sides of the cavity;
a steam generator that supplies steam to the cooking chamber;
a condensate collector in fluid communication with the cooking chamber so as to collect condensate formed from the steam supplied to the cooking chamber; and
a condensate guide positioned so as to guide condensate formed from steam, discharged from the cooking chamber and contacting an inner surface of the outer case, to the condensate collector.

9. The steam cooker of claim 8, wherein the condensate guide is positioned at a rear of the condensate collector.

10. The steam cooker of claim 8, wherein the condensate guide comprises at least one guide channel formed therein for guiding condensate to the condensate collector.

11. The steam cooker of claim 10, wherein the at least one guide channel extends into at least one corresponding collecting space formed in the condensate collector.

12. The steam cooker of claim 10, wherein the at least one guide channel is inclined downward at a preset angle toward at least one corresponding collecting space formed in the condensate collector.

13. A steam cooker, comprising:
a cavity comprising a cooking chamber;
a door that selectively opens and closes the cooking chamber;
an outer case covering a top and two lateral sides of the cavity;
a base plate provided under the cavity;
a steam generator that supplies steam to the cooking chamber;
a condensate collector positioned adjacent to the cavity so as to collect condensate formed from the steam supplied to the cooking chamber, the condensate collector comprising at least one collecting space in which the condensate is collected; and
a condensate guide coupled to the condensate collector, the condensate guide comprising at least one guide channel formed therein so as to guide condensate formed from steam contacting an inner surface of the outer case to the at least one collecting space formed in the condensate collector.

14. The steam cooker of claim 13, wherein the condensate collector is positioned under a front portion of a bottom surface of the base plate, and the condensate guide is positioned under the bottom surface of the base plate, to a rear of the condensate collector.

15. The steam cooker of claim 13, wherein the condensate collector is positioned corresponding to the door such that the at least one collecting space also collects condensate formed from steam contacting an inner surface of the door.

16. The steam cooker of claim 13, wherein the condensate guide comprises:
at least one support rib that extends upward so as to support the base plate; and
at least one base fixing part that fixes the condensate guide to the base plate.

17. The steam cooker of claim 13, wherein the condensate guide comprises at least one support rib that extends upward so as to support a bottom surface of the base plate, and wherein the at least one guide channel is defined by the at least one support rib and at least one of two opposite lateral sides of the condensate guide.

18. The steam cooker of claim 13, wherein the base plate comprises an exhaust port which directs air discharged from the cooking chamber into a space formed between the base plate and the condensate guide, and
wherein the condensate guide comprises a plurality of air outlets through which the air discharged into the space formed between the base plate and the condensate guide is discharged out of the condensate guide.

19. The steam cooker of claim 18, wherein the plurality of air outlets are provided in two opposite lateral sides of the condensate guide.

20. The steam cooker of claim 18, wherein the condensate guide comprises at least one support rib that extends upward to support a bottom surface of the base plate, and wherein at least one of the plurality of air outlets is formed by a cutaway portion of the support rib.
